(19) United States
(12) Patent Application Publication
(10) Pub. No.: US 2005/0028110 A1
(43) Pub. Date: Feb. 3, 2005

(54) Selecting functions in context

(75) Inventors: Christopher Vienneau, Montreal (CA); Michiel Schriever, Montreal (CA)

Correspondence Address: GATES & COOPER LLP;HOWARD HUGHES CENTER, 6701 CENTER DRIVE WEST, SUITE 1050, LOS ANGELES, CA, 90045, US

(73) Assignee: AUTODESK CANADA, INC., MONTREAL (CA)

(21) Appl. No.: 10/818,165

(22) Filed: Apr. 5, 2004

(30) Foreign Application Priority Data
Apr. 4, 2003 (GB) GB0307802.9

(51) Int. Cl. G09G 5/00

(52) U.S. Cl. 715/834; 715/835; 715/836; 715/837; 715/840; 715/841; 715/810

(57) ABSTRACT

A graphical user interface 1401 allows function commands 901, 902 to be selected, such as function commands applied to image data 503, 504. A first user-generated input command, such as the pressing of a spacebar 106 on a keyboard 105, displays a plurality of function gates (1407) at the position (1504) of a pointer 704 located within a context 1403. Movement of said pointer by a mouse 107, stylus 102 or similar device to one of said displayed gates (1505, 1506, 1507, 1508) results in the selection of a specific function 902. Alternatively, said pointer is moved to a different context 1402 and said first user-generated input command displays another plurality of function gates (1407) at the position (1509), wherein one of said displayed gates (1510, 1511, 1512) results in the selection of another specific function 908.

### CROSS-REFERENCE TO RELATED APPLICATIONS

This application claims the benefit under 35 U.S.C. §119 of the following co-pending and commonly assigned foreign patent application, which application is incorporated by reference herein:

United Kingdom Application No. 03 07 802.9, entitled “SELECTING FUNCTIONS IN CONTEXT”, by Christopher Vienneau and Michiel Schriever, filed on Apr. 4, 2003.

This application is related to the following commonly assigned patent applications, all of which applications are incorporated by reference:

U.S. patent application Ser. No. 08/617,400, entitled “MULTITRACK ARCHITECTURE FOR COMPUTER-BASED EDITING OF MULTIMEDIA SEQUENCES”, by David Hermanson, Attorney Docket No. 30566.151-US-01, filed Mar. 18, 1996 (now U.S. Pat. No. 5,892,506 issued Apr. 6, 1999);

U.S. patent application Ser. No. 08/630,131, entitled “PROCESSING IMAGE DATA”, by Benoit Sevigny, Attorney Docket No. 30566.170-US-01, filed Apr. 10, 1996 (now U.S. Pat. No. 5,786,824 issued Jul. 28, 1998); and

U.S. patent application Ser. No. 08/827,641, entitled “METHOD AND APPARATUS FOR COMPOSITING IMAGES”, by Benoit Sevigny, Attorney Docket No. 30566.180-US-01, filed Apr. 9, 1997 (now U.S. Pat. No. 6,269,180 issued Jul. 31, 2001).

### FIELD OF THE INVENTION

The present invention relates to apparatus for processing image data and a method of selecting a contextual function via a graphical user interface.

### DESCRIPTION OF THE RELATED ART

Systems for processing image data, having a processing unit, storage devices, a display device and a stylus-like manually operable input device (such as a stylus and touchtablet combination) are shown in U.S. Pat. Nos. 5,892,506; 5,786,824 and 6,269,180 all assigned to the present Assignee. In these aforesaid systems, it is possible to perform many functions upon stored image data in response to an operator manually selecting a function from a function menu.

Recently, in such systems as “TOXIC”, “FIRE” and “INFERNO”, licensed by the present Assignee, the number of functions that may be performed have increased significantly. Thus, for example, there has been a tendency towards providing functions for special effects, compositing and editing on the same platform.

Function selection is often done via graphical user interfaces (GUIs) in which menus are displayed from which a selection may be made. A function selection using a menu is achieved by moving a cursor over to a selection position within the menu by operation of the stylus. The particular function concerned is selected by placing the stylus into pressure; an operation logically similar to a mouse click. Menus of this type are used in systems where stylus-like input devices are preferred over pull-down menus, given that it is necessary to maintain stylus pressure while menu selection takes place with such pull-down menus. Such an operation places unnecessary strain on the wrists and fingers of an operator and is therefore not preferred in applications that make significant use of stylus-like devices.

In addition to there being a trend towards increasing the level of functionality provided by digital image processing systems, there has also been a trend towards manipulating images of higher definition. For instance, image frames of motion pictures are traditionally captured on stock film and subsequently digitised for image editing professionals to edit such frames in post-production, for example to blend computer-generated special effects image data therein, a function known to those skilled in the art as compositing. Modern developments in image capture technology have yielded advanced film stock, such as the well known 65 millimetres IMAX film, and digital cameras, wherein image frames captured by either have higher resolutions to depict their content with much more detail over a larger projection support, whereby such resolutions are known to reach 16,000×16,000 pixels. Comparatively, known image processing systems, such as Silicon Graphics Fuel(tm) or Octane2(tm) workstations manufactured by Silicon Graphics Inc of Mountain View, Calif., USA may be used to process both types of digitised frames, and are typically limited to an optimum frame display size of about 2000×2000 pixels.

In this context, comparing the increasing resolution of the above high-definition image frames with the maximum display resolution offered by current image processing systems highlights a growing problem, in that said GUI itself requires a substantial amount of the image frame displayable by said systems, whereby the portion of displayable image frame taken by said GUI is at the expense of the portion of displayable full-resolution image frame to be worked upon.

Furthermore, operators and artists are under increasing pressure to increase the rate at which work is finished. Being able to work with systems of this type quickly and efficiently is not facilitated if complex menu structures are provided or manipulation tools are provided that are not intuitive to the way artists work.

### BRIEF SUMMARY OF THE INVENTION

According to a first aspect of the present invention, there is provided an apparatus for processing image data, comprising processing means, memory means, display means and manually operable input means, wherein said processing means is configured to perform functions upon said image data in response to an operator manually selecting said image data and at least one function within a context; said processing means responds to a first user-generated input command so as to identify said context and display a plurality of context-dependent function regions at a pointer position located within said context; said processing means processes input data from said input means so as to translate said pointer to one of said function regions and manual selection of a function region results in the selected function being performed upon said selected image data.

According to another aspect of the present invention, a method of selecting a function via a graphical user interface for receiving input commands is provided, wherein functions are performed upon image data in response to an operator manually selecting said image data and at least one function within a context; a first input command is generated so as to identify said context and display a plurality of context-dependent function regions at a pointer position located within said context; input data from said input means is processed to translate said pointer to one of said function regions, whereby manual selection of a function region results in the selected function being performed upon said selected image data.

According to yet another aspect of the present invention, a computer-readable medium is provided having computer-readable instructions executable by a computer such that, when executing said instructions, said computer will perform the steps of performing functions upon image data in response to an operator manually selecting said image data and at least one function within a context; responding to a first user-generated input command so as to identify said context and display a plurality of context-dependent function regions at a pointer position located within said context; processing input data from said input means so as to translate said pointer to one of said function regions, whereby manual selecting of a function region results in the selected function being performed upon said selected image data.

### BRIEF DESCRIPTION OF THE SEVERAL VIEWS OF THE DRAWINGS

FIG. 1 shows a system for processing image data that embodies the present invention;

FIG. 2 details the hardware components of the computer system shown in FIG. 1, including a memory;

FIG. 3 illustrates a scene shown in a movie theatre comprising image data processed by the system shown in FIGS. 1 and 2;

FIG. 4 further illustrates the image data and structure thereof shown in FIG. 3;

FIG. 5 details the processing steps according to which an image editor operates the image processing system shown in FIGS. 1 and 2 according to the present invention, including a step of starting the processing of an application;

FIG. 6 shows the contents of the memory shown in FIG. 2 after performing the step of starting the processing of an application shown in FIG. 5;

FIG. 7 illustrates image data selection in the graphical user interface of an image editing application configured according to the known prior art;

FIG. 8 illustrates image data processing functions in the graphical user interface of an image editing application configured according to the known prior art;

FIG. 9 further shows functions and contexts initialised during the step of starting the processing of an application shown in FIG. 5 according to the present invention;

FIG. 10 details the processing step according to which the scene data shown in FIGS. 3, 4, 7 and 8 is edited in an image processing system configured according to the present invention, including steps of displaying and removing a multilateral device;

FIG. 11 further details the operational step of displaying a multilateral device shown in FIG. 10, including a step of deriving a context;

FIG. 12 details the operational step of deriving a context shown in FIG. 11;

FIG. 13 further details the operational step of removing a multilateral device shown in FIGS. 10 and 11;

FIG. 14 shows the graphical user interface shown in FIG. 7 configured according to the present invention, including two portions each having a context;

FIG. 15 shows the graphical user interface shown in FIG. 14 configured according to the present invention, including two portions each having a different context;

FIG. 16 shows the graphical user interface shown in FIG. 15 configured according to an alternative embodiment of the present invention.

### WRITTEN DESCRIPTION OF THE BEST MODE FOR CARRYING OUT THE INVENTION

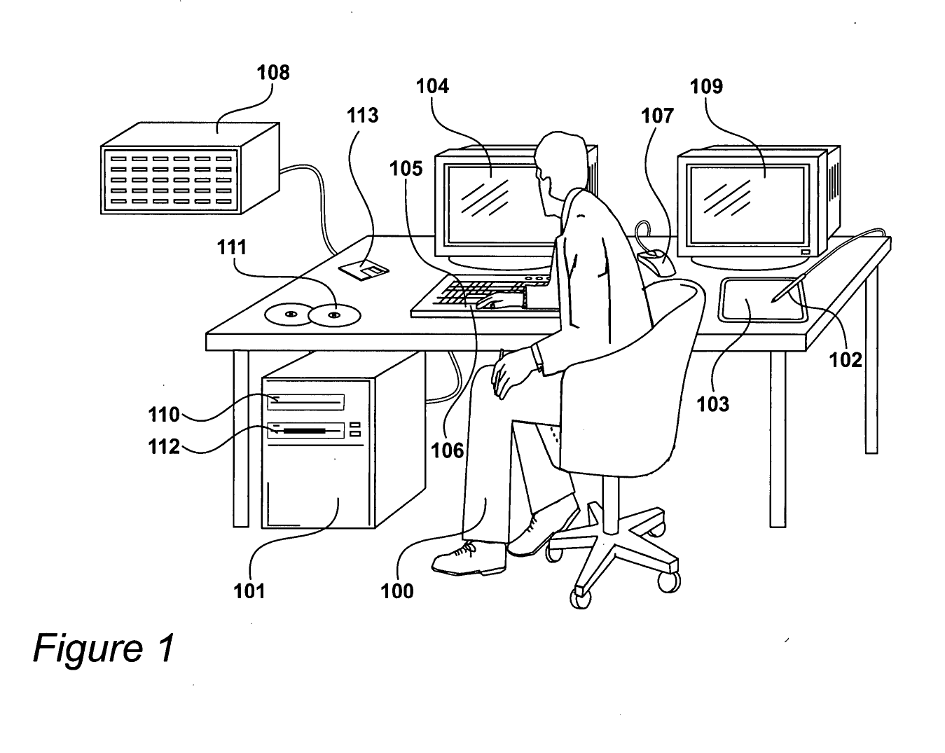

FIG. 1

A computer editing system, including a computer system video display unit and a high-resolution monitor, is shown in FIG. 1.

In the system shown in FIG. 1, instructions are executed upon a graphics workstation operated by an artist 100, the architecture and components of which depends upon the level of processing required and the size of images being considered. Examples of graphics-based processing systems that may be used for very-high-resolution work include an ONYX II manufactured by Silicon Graphics Inc, or a multiprocessor workstation 101 manufactured by IBM Inc. The processing system 101 receives instructions from an artist by means of a stylus 102 applied to a touch tablet 103, in response to visual information received by means of a visual display unit 104. The visual display unit 104 displays images, menus and a cursor and movement of said cursor is controlled in response to manual operation of a stylus 102 upon a touch table 103. Keyboard 105 is of a standard alpha numeric layout and includes a spacebar 106. Manual operation of the spacebar 106 provides a first input command in a preferred embodiment resulting in a multilateral device being displayed at the cursor position, wherein said multilateral device identifies a function type at each of its sections, each having an associated displayable menu. Reference may be made to British co-pending application No. 02 16 824.3 for a definition of said multilateral device, the teachings of which are incorporated herein for reference.

In response to a second input command, preferably received from the stylus 102, the cursor is moved over one of the edges of the displayed multilateral device. Thereafter, having moved the cursor over an edge of the multilateral device, the aforesaid menu associated with the edge over which the cursor has been moved is displayed. In this way, a user is given rapid access to a menu of interest without said menu being continually displayed over the working area of the VDU 104.

In addition, data may be supplied by said artist 100 via a mouse 107, with input source material being received via a real-time digital video recorder or similar equipment configured to supply high-bandwidth frame data.

The processing system 101 includes internal volatile memory in addition to bulk, randomly-accessible storage, which is provided by means of a RAID disk array 108. Output material may also be viewed by means of a high-quality broadcast monitor 109. System 101 includes an optical data-carrying medium reader 110 to allow executable instructions to be read from a removable data-carrying medium in the form of an optical disk 111, for instance a DVD-ROM. In this way, executable instructions are installed on the computer system for subsequent execution by the system. System 101 also includes a magnetic data-carrying medium reader 112 to allow object properties and data to be written to or read from a removable data-carrying medium in the form of a magnetic disk 113, for instance a floppy-disk or a ZIP™ disk.

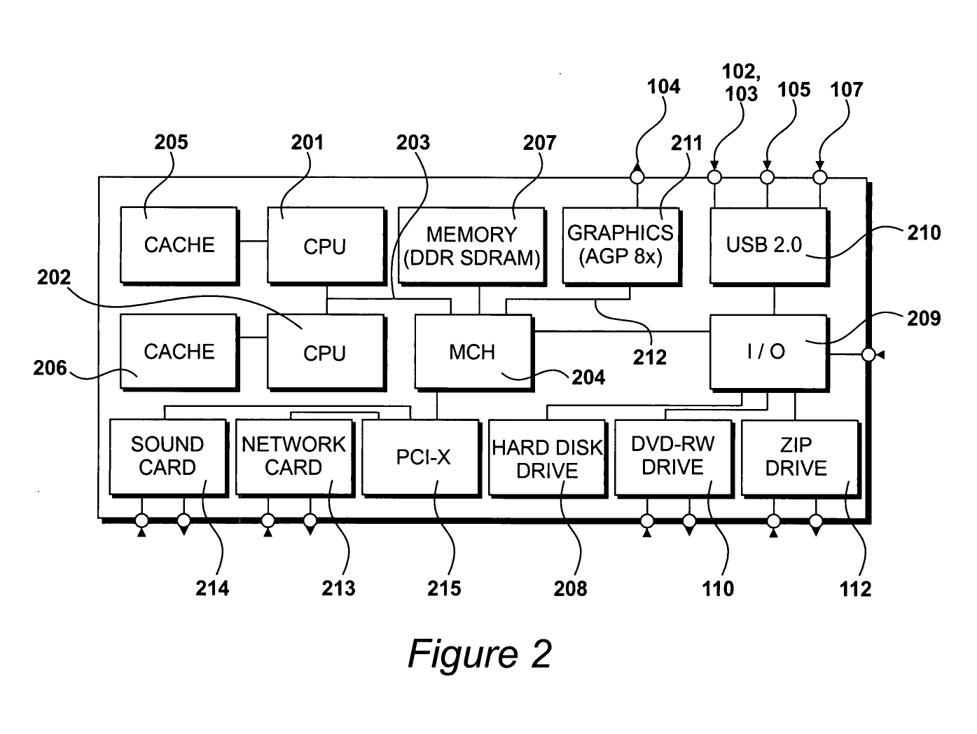

FIG. 2

The components of computer system 101 are further detailed in FIG. 2 and, in the preferred embodiment of the present invention, said components are based upon Intel® E7505 hub-based Chipset.

The system includes two Intel® Pentium™ Xeon™ DP central processing units (CPU) 201, 202 running at three Gigahertz, which fetch and execute instructions and manipulate data with using Intel®'s Hyper Threading Technology via an Intel® E7505 533 Megahertz system bus 203 providing connectivity with a Memory Controller Hub (MCH) 204. CPUs 201, 202 are configured with respective high-speed caches 205, 206 comprising at least five hundred and twelve kilobytes, which store frequently-accessed instructions and data to reduce fetching operations from a larger memory 207 via MCH 204. The MCH 204 thus co-ordinates data flow with a larger, dual-channel double-data rate main memory 207, which is between two and four gigabytes in data storage capacity and stores executable programs which, along with data, are received via said bus 203 from a hard disk drive 208 providing non-volatile bulk storage of instructions and data via an Input/Output Controller Hub (ICH) 209. Said ICH 209 similarly provides connectivity to DVD-ROM re-writer 110 and ZIP™ drive 112, both of which read and write data and instructions from and to removable data storage media. Finally, ICH 209 provides connectivity to USB 2.0 input/output sockets 210, to which the stylus 102 and tablet 103 combination, keyboard 105 and mouse 107 are connected, all of which send user input data to system 101.

A graphics card 211 receives graphics data from CPUs 201, 202 along with graphics instructions via MCH 204. Said graphics accelerator 211 is preferably coupled to the MCH 204 by means of a direct port 212, such as the direct-attached advanced graphics port 8X (AGP 8X) promulgated by the Intel® Corporation, the bandwidth of which exceeds the bandwidth of bus 203. Preferably, the graphics card 211 includes substantial dedicated graphical processing capabilities, so that the CPUs 201, 202 are not burdened with computationally intensive tasks for which they are not optimised.

Network card 213 provides connectivity to the framestore 108 by processing a plurality of communication protocols, for instance a communication protocol suitable to encode and send and/or receive and decode packets of data over a Gigabit-Ethernet local area network. A sound card 214 is provided which receives sound data from the CPUs 201, 202 along with sound processing instructions, in a manner similar to graphics card 211. Preferably, the sound card 214 includes substantial dedicated digital sound processing capabilities, so that the CPUs 201, 202 are not burdened with computationally intensive tasks for which they are not optimised. Preferably, network card 213 and sound card 214 exchange data with CPUs 201, 202 over system bus 203 by means of Intel®'s PCI-X controller hub 215 administered by MCH 204.

The equipment shown in FIG. 2 constitutes a typical workstation comparable to a high-end IBM™ PC compatible or Apple™ Macintosh.

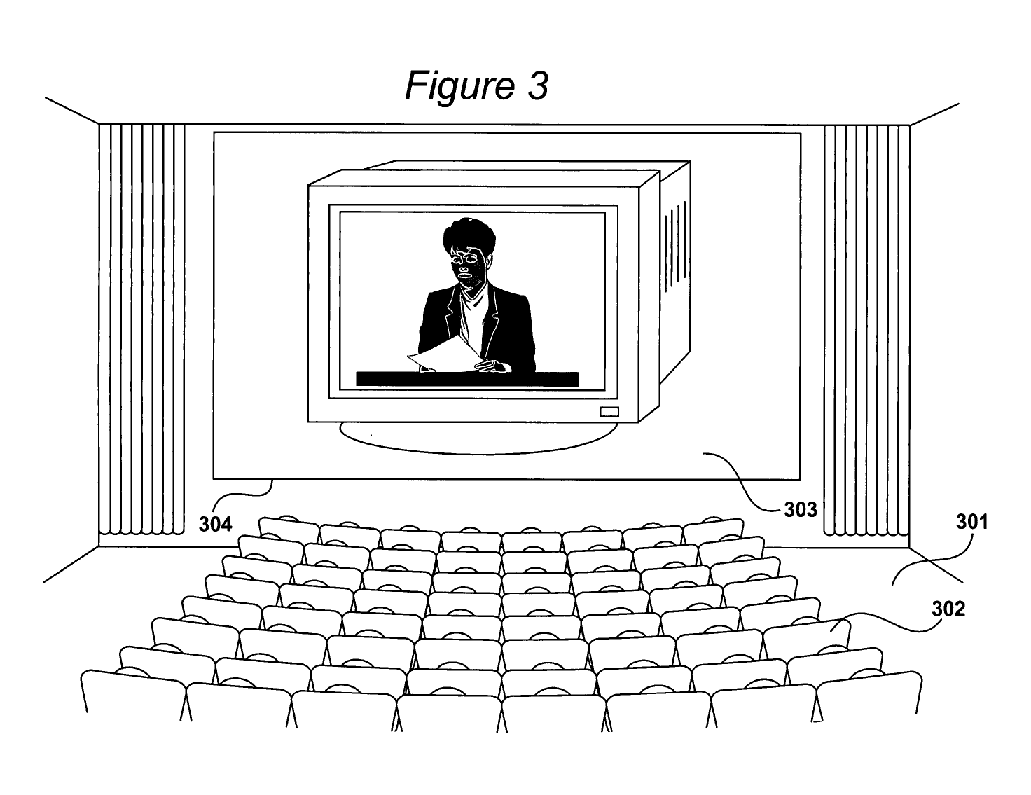

FIG. 3

A conventional movie theatre 301 is shown in FIG. 3, in which an audience 302 is watching a scene 303 projected onto a movie screen 304. Scene 303 comprises a sequence of many thousands of high-definition image frames exposed on film stock, thus having a very high resolution necessary to realistically portrait the contents thereof when magnified by the projector onto screen 304, having regard to the amount of detail observable by audience 302 therein.

As was detailed in the introduction above, it is known to digitise source image frames contributing to the sequence 303 for the purpose of post-production editing and the implementation of image enhancements. In modern image-processing systems, such high-definition images comprise possibly hundreds of different screen elements, which may be understood as the total number of processing functions to be performed upon the original image frame digitised from film. Editing these image frames therefore potentially involve editing the criteria according to which each of said functions processes said original frame. In order to facilitate said editing and enhancements, various image data processing techniques have been developed to improve the interaction of an image editor such as artist 100 therewith, and the workflow thereof. Specifically, one such technique involves the referencing of said digitised image frames and the various post-production processes applied thereto within a hierarchical data processing structure, also known as a process tree or scene graph, whereby said image editor may intuitively and very precisely edit any component or object of any digitised image frame referenced therein.

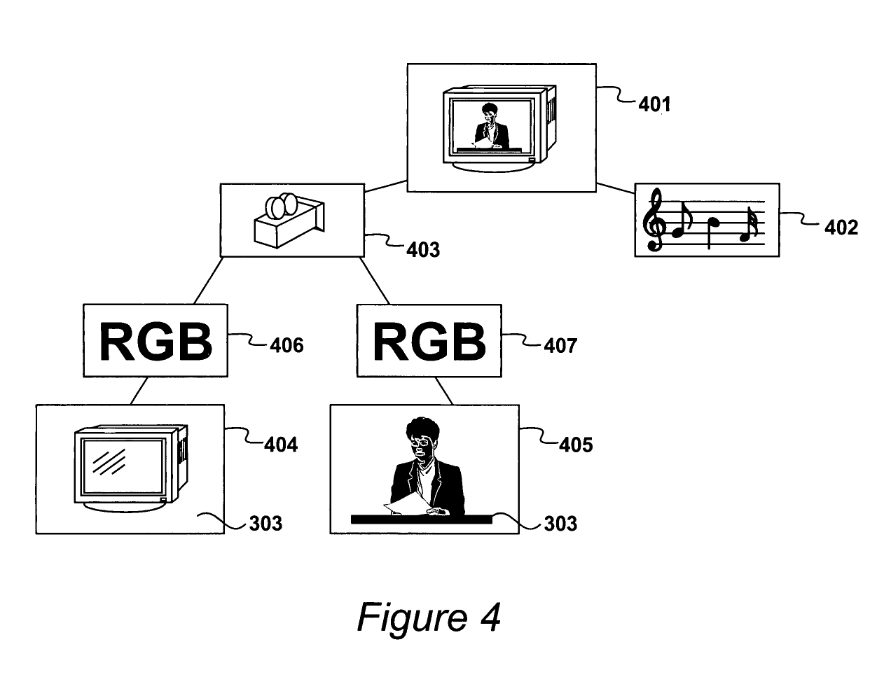

FIG. 4

A simplified example of the process tree of sequence 303 is shown in FIG. 4.

In compositing applications processed by the processing system shown in FIGS. 1 and 2, the scene graph of sequence 303 is traditionally represented as a top-down tree structure, wherein the topmost node 401 pulls all the data output by nodes depending therefrom in order to output final output data, some of which will be image data and some of which may be audio data, for instance generated by a first audio child node 402.

In order to generate image data by way of image rendering, a fundamental requirement is the definition of a rendering camera and its view frustrum, as defined by a rendering node 403. In the example, said final output image frame is a composited image frame which includes a background image frame depicting a TV set and a foreground image frame depicting a TV presenter to be keyed therewith. Consequently, the TV background image frame is output by a frame node 404 and the presenter foreground image frame is output by a frame node 405, wherein said frame nodes are children of rendering node 403.

If the R,G,B color component values of both the background and foreground image frames require correction independently of one another before said final frame is rendered, color-correction nodes 406, 407 may be added as respective parent nodes of frame nodes 404, 405, wherein said nodes 406, 407 respectively pull the image data output by frame nodes 404, 405 in order to process it and effect said correction before rendering node 403 can render said color-corrected final output frame.

The scene graph shown in FIG. 4 is very small and restricted for the purpose of not obscuring the present description unnecessarily. However, it will be readily apparent to those skilled in the art that such scene graphs usually involve hundreds or even thousands of such hierarchical data processing nodes.

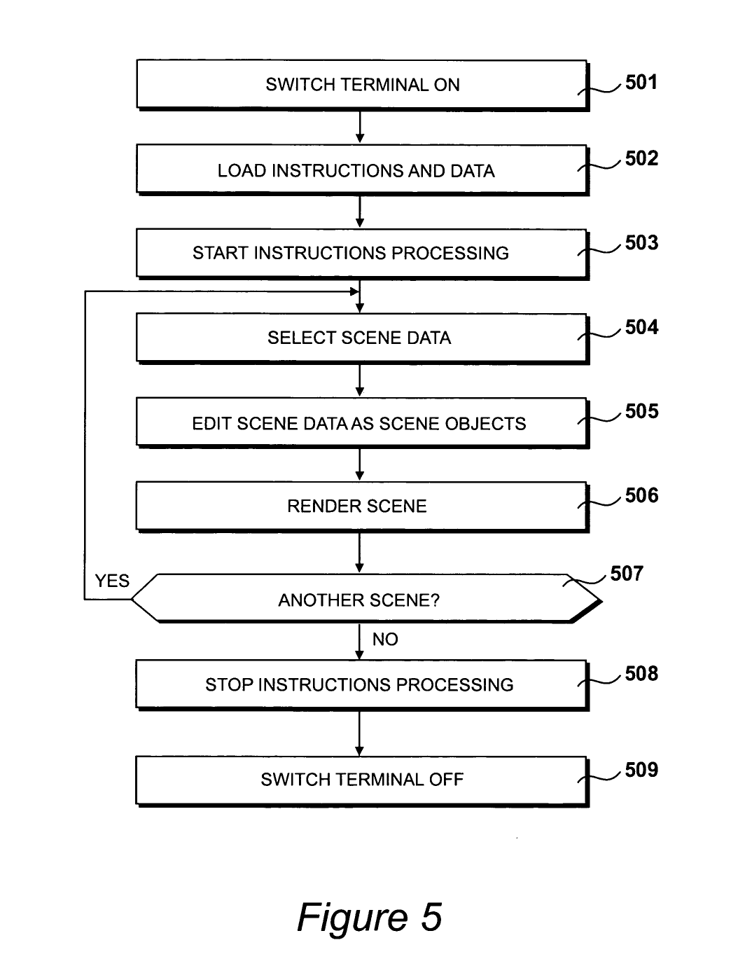

FIG. 5

The processing steps according to which artist 100 may operate the image processing system shown in FIGS. 1 and 2 according to the present invention are described in FIG. 5.

At step 501, artist 100 switches on the image processing system and, at step 502, an instruction set is loaded from hard disk drive 208, DVD ROM 111 by means of the optical reading device 110 or magnetic disk 113 by means of magnetic reading device 112, or even a network server accessed by means of network card 213.

Upon completing the loading of step 502 of instructions set into memory 207, CPUs 201, 202 may start processing said set of instructions, also known as an application, at step 503. User 100 may then select a scene graph such as described in FIG. 4 at step 504. Upon performing the selection of step 504, artist 100 may now perform a variety of processing functions upon the image data of the scene graph at step 505, whereby a final composite image frame may then output at step 506 by means of rendering the edited scene.

At step 507, a question is asked as to whether the image data of another scene requires editing at step 505 and rendering at step 506. If the question of step 507 is answered positively, control is returned to step 504, whereby another scene may then be selected. Alternatively, if the question of 507 is answered negatively, signifying that artist 100 does not require the functionality of the application loaded at step 502 anymore and can therefore terminate the processing thereof at step 508. Artist 100 is then at liberty to switch off the image processing system 101 at step 509.

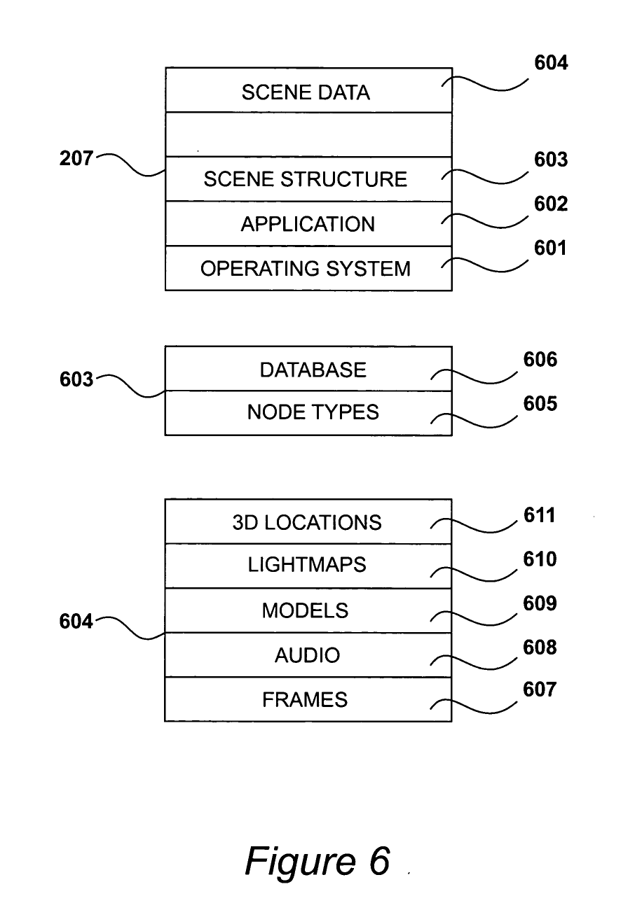

FIG. 6

The contents of main memory 207 subsequently to the selection step 504 of a scene are further detailed in FIG. 6.

An operating system is shown at 601 which comprises a reduced set of instructions for CPUs 201, 202 the purpose of which is to provide image processing system 101 with basic functionality. Examples of basic functions include for instance access to files stored on hard disk drive 208 or DVD/CD-ROM 111 or ZIP(tm) disk 113 and management thereof, network connectivity with a network server and frame store 108, interpretation and processing of the input from keyboard 105, mouse 107 or graphic tablet 102, 103. In the example, the operating system is Windows XP(tm) provided by the Microsoft corporation of Redmond, Calif., but it will be apparent to those skilled in the art that the instructions according to the present invention may be easily adapted to function under different other known operating systems, such as IRIX(tm) provided by Silicon Graphics Inc or LINUX, which is freely distributed.

An application is shown at 602 which comprises the instructions loaded at step 502 that enable the image processing system 101 to perform steps 503 to 507 according to the invention within a specific graphical user interface displayed on VDU 104. Application data is shown at 603 and 604 and comprises various sets of user input-dependent data and user input-independent data according to which the application shown at 602 processes image data. Said application data primarily includes a data structure 603, which references the entire processing history of the image data as loaded at step 504 and hereinafter may be referred to as a scene graph. According to the present invention, scene structure 603 includes a scene hierarchy which comprehensively defines the dependencies between each component within an image frame as hierarchically-structured data processing nodes, as will be further described below.

Scene structure 603 comprises a plurality of node types 605, each of which provides a specific functionality in the overall task of rendering a scene according to step 506. Said node types 605 are structured according to a hierarchy 606, which may preferably but not necessarily take the form of a database, the purpose of which is to reference the order in which various node types 605 process scene data 604.

Further to the scene structure 603, application data also includes scene data 604 to be processed according to the above hierarchy 606 in order to generate one or a plurality of image frames, i.e. the parameters and data which, when processed by their respective data processing nodes, generate the various components of a final composite image frame.

A number of examples of scene data 604 are provided for illustrative purposes only and it will be readily apparent to those skilled in the art that the subset described is here limited only for the purpose of clarity. Said scene data 604 may include image frames 607 acquired from framestore 108, for instance a background image frame digitized from film and subsequently stored in frame store 108, portraying a TV set and a foreground image frame digitized from film and subsequently stored in frame store 108, portraying a TV presenter.

Said scene data 604 may also include audio files 608 such as musical score or voice acting for the scene structure selected at step 504. Said scene data 604 may also include pre-designed three-dimensional models 609, such as a camera object required to represent the pose of the rendering origin and frustrum of a rendering node within the compositing environment, which will be described further below in the present description. In the example, scene data 604 includes lightmaps 610, the purpose of which is to reduce the computational overhead of CPUs 201, 202 when rendering the scene with artificial light sources. Scene data 604 finally include three-dimensional location references 611, the purpose of which is to reference the position of the scene objects edited at step 505 within the three-dimensional volume of the scene compositing environment.

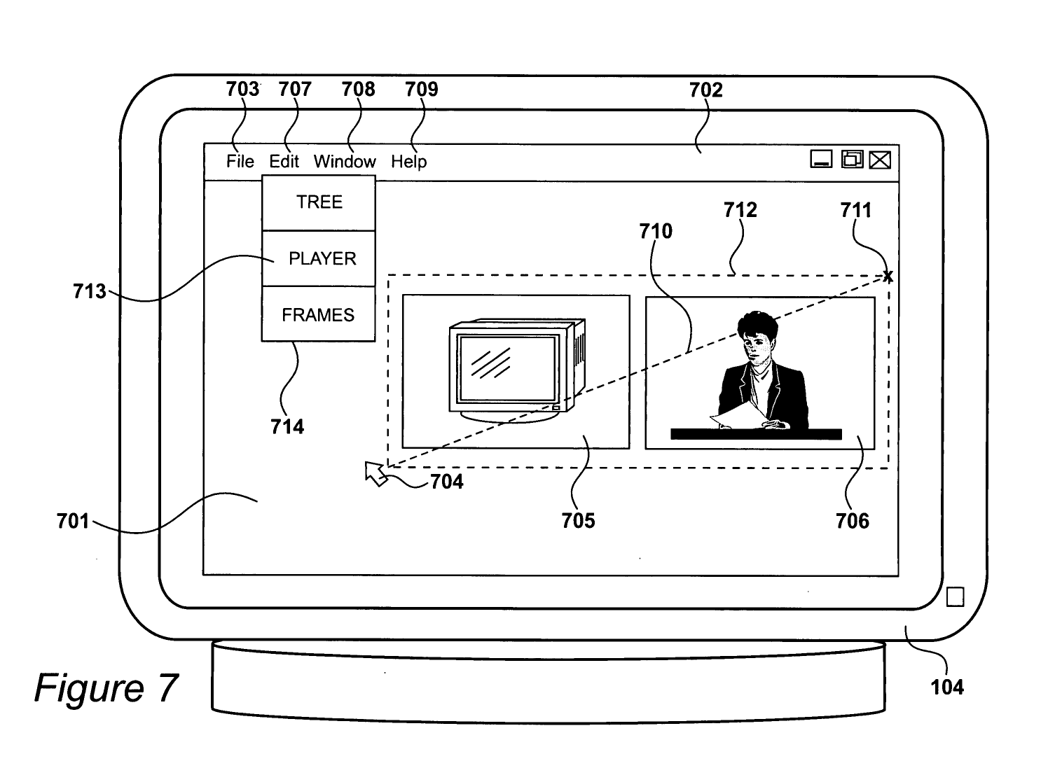

FIG. 7

The default graphical user interface of application 602 output to display 104 upon completing the application loading and starting steps 502 and 503 and the image data selection of step 504 is shown in FIG. 7.

According to the present invention, the image data shown in FIGS. 3 to 6 may be edited by an image editor with image processing application 602 processed by image processing system 101. Upon completing loading and starting steps 502, 503, said system 101 outputs a default graphical user interface (GUI) 701 of the image processing application 602 to display means 104 for interaction by said user therewith, within which representations of image-processing functions are displayed for selection and are alternatively named menus, icons and/or widgets by those skilled in the art.

GUI 701 firstly comprises a conventional menu toolbar 702, having a plurality of function representations thereon. A first representation 703 defines a “File” management menu which, when selected by artist 100 by means of positioning a GUI pointer 704 thereon with translating mouse 107 or stylus 102 over tablet 103 and subsequently effecting a mouse click or tapping said stylus 102 over said tablet 103, generates a conventional “drop-down” sub-menu (not shown) configured with further representations of file management functions, such as an “open file” function for instance. In the example, user 100 performs the above interaction in order to select image data at step 504 as image frame sequences respectively output by frame nodes 404, 405, which are then accessed at framestore 108 and stored in memory 207 as image data 607, and respective proxies 705, 706 thereof subsequently displayed within GUI 701.

Menu bar 702 may include a plurality of further library representations, such as an edit menu 707, a window library 708 and a help library 709, which are well known to those skilled in the art. The taskbar 702 and drop-down menus thereof are a very common design and traditionally implemented in the majority of applications processed within the context of a multi-tasking operating system, such as the Windows®-based operating system of the preferred embodiment.

In the example still, the workflow of user 100 requires an edit function of edit menu 707 to be performed upon sequences 705, 706, wherein said sequences have to be synchronised for playback when keyed into a final output composite sequence as illustrated in FIG. 3. That is, each foreground image frame of the “TV presenter” sequence output by frame node 405 is keyed in a corresponding background image frame of the “TV set” sequence output by frame node 404, wherein the respective playback of each sequence for rendering at step 506 should be matched. Said synchronisation is required because said “TV set” sequence includes high-resolution movie frames with a playback rate of twenty-four frames per second but said “TV presenter” sequence includes PAL video frames with a playback rate of thirty frames per second.

In order to perform this “synchronisation” edit function in a system configured according to the known prior art, user 100 would select the proxies 705, 706 with pointer 704 by translating said pointer along a path 710, wherein an image-processing application configured according to the known prior art processes the start 704 and end 711 X,Y screen co-ordinates of pointer 704, which is preferably translated with mouse 107 having a button depressed along said path 1501 or stylus 102 in contact with tablet 103 along said path 1501, in order to define a bounding box 712 logically grouping proxies 705, 706. In said prior art system and GUI thereof, user 100 would subsequently select a “player” group 713 of functions from the “drop-down” menu 714 generated by translating pointer 704 from GUI location 711 over “edit” menu 707 and effecting a mouse click or stylus tap on tablet 103.

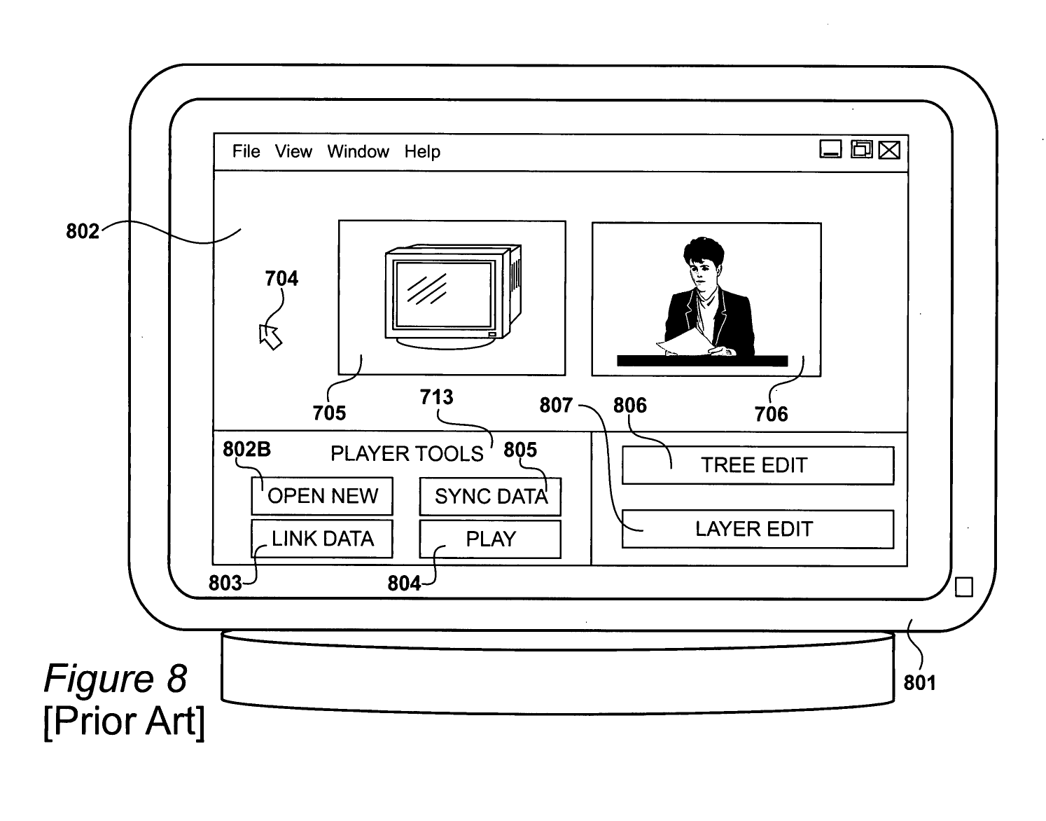

FIG. 8

A prior art system is illustrated in FIG. 8 by the graphical user interface (GUI) of an image editing application, wherein said GUI is updated further to the “player” functions selection according the known prior art as described in FIG. 7.

A monitor 801 of said prior art system and not that shown in FIGS. 1 and 7 displays the graphical user interface (GUI) 802 of an image processing application configured to display proxies 705, 706 of image data 607 and icons of image processing functions corresponding to the “player” group of functions 713.

Said icons include a first “Open New” player function icon 802B, the activation of which by user 100 by way of pointer 704 instructs the image-processing application to load new image data, according to steps 507, 504, much in the same way as if user 100 were to select the “open file” function of file menu 703 as described in FIG. 7. A second “link data” player function icon 803 is shown, the activation of which by user 100 by way of pointer 704 instructs the application to logically link the image data shown as proxies 705, 706, i.e. define a parent, child or sibling relationship within the context of the scene graph. A third “play data” player function icon 804 is shown, the activation of which by user 100 by way of pointer 704 instructs the application to play either or both of the image frame sequences shown as proxies 705, 706, i.e. display each frame of one such sequence according to the frame rate thereof, e.g. twenty-four frames of the “TV set” sequence per second.

A fourth “sync data” player function icon 805 is shown, which is the function of interest to user 100 in the example. The activation of icon 805 by user 100 by way of pointer 704 instructs the application to synchronize the playback of the selected image data shown as proxies 705, 706, for instance by way of processing the total number of frames for each sequence and generating additional keyframes in the sequence having the least number of frames.

Further icons may be implemented within GUI 802, which vary according to the design thereof and level of user-operability conferred thereto, such as representations of further functions available in the drop-down menu 714 of the edit menu 707, for instance a “tree edit” icon 806 and a “layer edit” icon 807, in order to spare user 100 the need to again select said edit menu 707 and another function 806, 807 in dropdown menu 714, if so required by the workflow.

Regardless of whether such further icons and levels of menus and sub-menus are implemented in the GUI 802 of the application configured according to the prior art, the display portion taken up by icons 802B to 807 significantly restricts the amount of display space of monitor 801 made available to display a frame such as the movie-resolution “TV set” frame at full resolution, for instance if user 100 wants to play sequence 705 at said full resolution before effecting function 805. Moreover, the iterative nature of the selection of any of representations 703, 707, 708, 709, 713 and 802B to 807, requires an image editor to learn which image processing functions are represented in which menu or function group, such as icon group 713, depending upon a particular workflow, whereby said learning is in conflict with the production time imperative described in the introduction and further compounded by the growing number of said functions, thus menus and icons.

The present invention solves this problematic situation with a context-sensitive multilateral graphical user interface device, wherein the need to display menus and icons as described in FIG. 8 is obviated by said device being configured with dynamic function-representative regions, the respective number and contents of which change according to the functions that may be performed upon selected image data in various contexts.

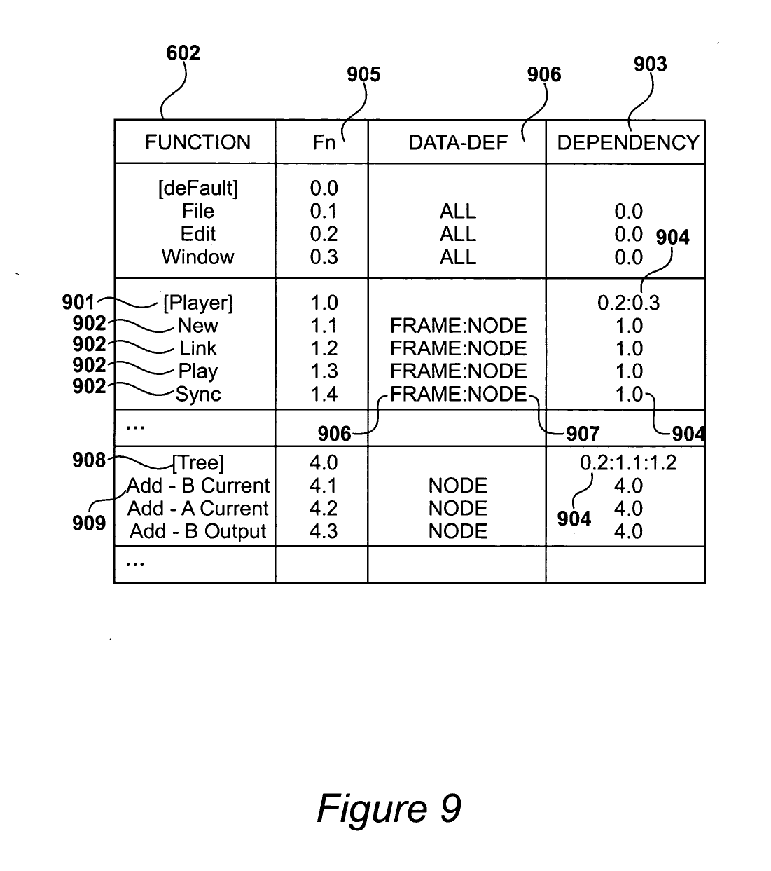

FIG. 9

The processing step 503 according to which a preferred embodiment of the present invention configures the image processing system shown in FIGS. 1 and 2, 5 to 7 and 9 to load an image processing application is further detailed in FIG. 9.

At said step 503, a loading module loaded first at the previous step 502 sorts function groups 901 and the respective functions 902 thereof in order to define a function dependency list 903, which comprehensively references all of the inter-dependencies 904 existing between all of the functions of said instructions set. In effect, said dependency list 903 references said inter-dependencies 904 as a hierarchy 905 of all of the data-processing functions implemented within an image-processing application 602, since each of said functions 902 inherits data definitions 906 from its respective group definition 901, but may share all or a portion of these with other functions depending from other libraries.

The concept of function dependencies is well known to those skilled in the art and is paramount to achieve adequate processing of input data, because each of said functions 902 must “know” the type of data 906 it may receive from a sibling function, i.e. a function 902 belonging to the same group 901, and also the type of data 907 it outputs itself, in order to determine which alternative group 908 should be called if said processed data shall be forwarded to a processing function 909 belonging to said different group 908.

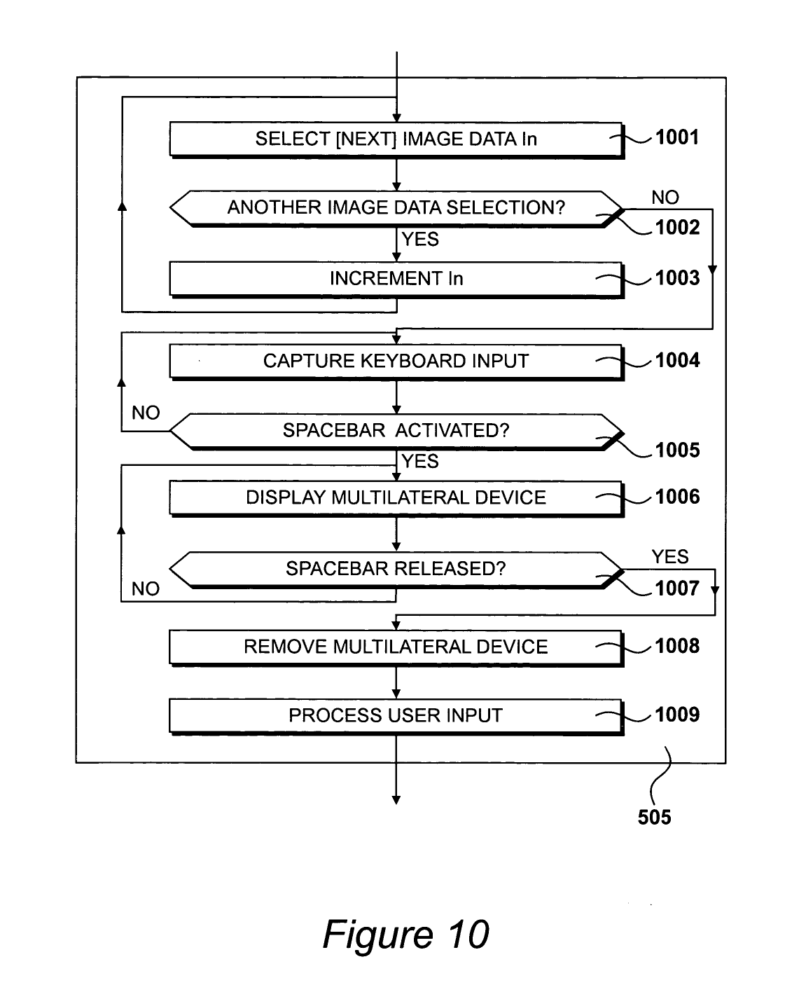

FIG. 10

The processing step 505 according to which artist 100 may operate the image processing system shown in FIGS. 1 and 2, 5 to 7 and 9 to edit scene data according to the present invention is further detailed in FIG. 10.

At step 1001, artist 100 selects first image data In, for instance the “TV set” image frame sequence output by frame node 404, which is then accessed at framestore 108 and stored in memory 207 as image data 607. Said selected first image data is preferably stored within a portion of memory 207 configured as a first-in first-out (FIFO) buffer.

At step 1002, a question is asked as to whether second image data ln+i, for instance the “TV presenter” image frame sequence output by frame node 405, should be selected. If question 1002 is answered positively, control proceeds to step 1003 for image data reference incrementing and subsequently returned to step 1001 to perform said second selection, whereby said second image data is then also accessed at framestore 108 and stored in memory 207 as image data 607. Said selected second image data is also preferably stored within a portion of memory 207 configured as said FIFO buffer, such that upon selecting a data processing function, the order in which first and second image data were selected is preserved.

Alternatively or eventually, the question of step 1002 is answered negatively and a keyboard operation is captured at step 1004. At step 1005 a question is asked as to whether the spacebar 106 has been activated. If answered in the negative, control is returned to step 1004, else control is directed to step 1006. In response to the spacebar 106 being activated and detected at step 1005, a multilateral graphical user interface device is displayed at step 1006. At step 1007 a question is asked as to whether the spacebar 106 has been released and, if answered in the negative, the control is returned to step 1006 in order to update said multilateral graphical user interface device.

Alternatively, the question of step 1007 is answered positively, whereby said multilateral graphical user interface device is removed at step 1008 such that the application 602 responds to further movements of pointer 704, imparted by user 100 to edit the variables of the function selected by means of said multilateral graphical user interface device at step 1009.

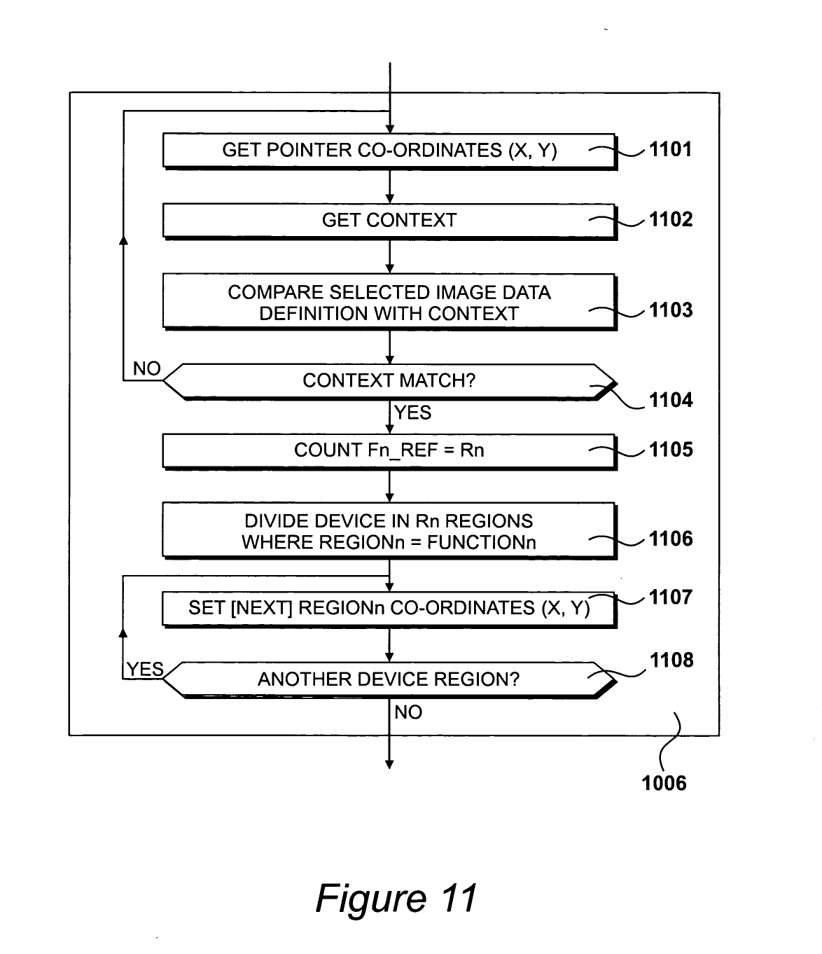

FIG. 11

The step 1006 of displaying a context-sensitive, multilateral GUI device according to the present invention is further detailed in FIG. 11.

At step 1101, the two-dimensional X, Y screen co-ordinates of pointer 704 are derived by application 602 processing the planar X, Y input imparted by user 100 onto mouse 107 or stylus 102 over tablet 103. Said pointer co-ordinates allow application 602 to derive a GUI context 901 which will be further described in the present description at step 1102, in order to compare the data definition of the image data selected according to steps 1001 to 1003 stored in database 506 with the data definition 906 of said context 901 at the next step 1103.

A first question is subsequently asked at step 1104, as to whether the comparison of step 1103 results in a context data definition match. If the question of the step 1104 is answered negatively, control is returned to step 1101, wherein if user 100 has further translated pointer 704, new pointer co-ordinates are obtained at step 1101 for comparison according to steps 1102-1104. The question at step 1104 is eventually answered positively, wherein application 602 performs a count of the number Rn of function references 905 within the context 901 identified at step 1102, at step 1105. At the next step 1106, application 602 divides the multilateral device of the present invention in a number of distinct regions according to said function reference number Rn, wherein each of said regions is respectively associated with one of said functions 902 of said context 901.

At step 1107, application 602 associates a first portion of its GUI with the first region generated from step 1106, expressed as a set of two-dimensional X, Y screen co-ordinates. A second question is asked at step 1108, as to whether another device region Rn+i remains to which a portion of said application GUI should be associated according to step 1107. Thus, if the question of step 1108 is answered positively, control is returned to step 1107, whereby a second region of said GUI is similarly associated to said next device region Rn₊₁, and so and so forth. The question at step 1108 is eventually answered negatively, whereby the multilateral device of the present invention is displayed within said application GUI and is configured with a number of user-operable GUI device regions, the number of which depends upon the number Rn of functions 902 of a context 901.

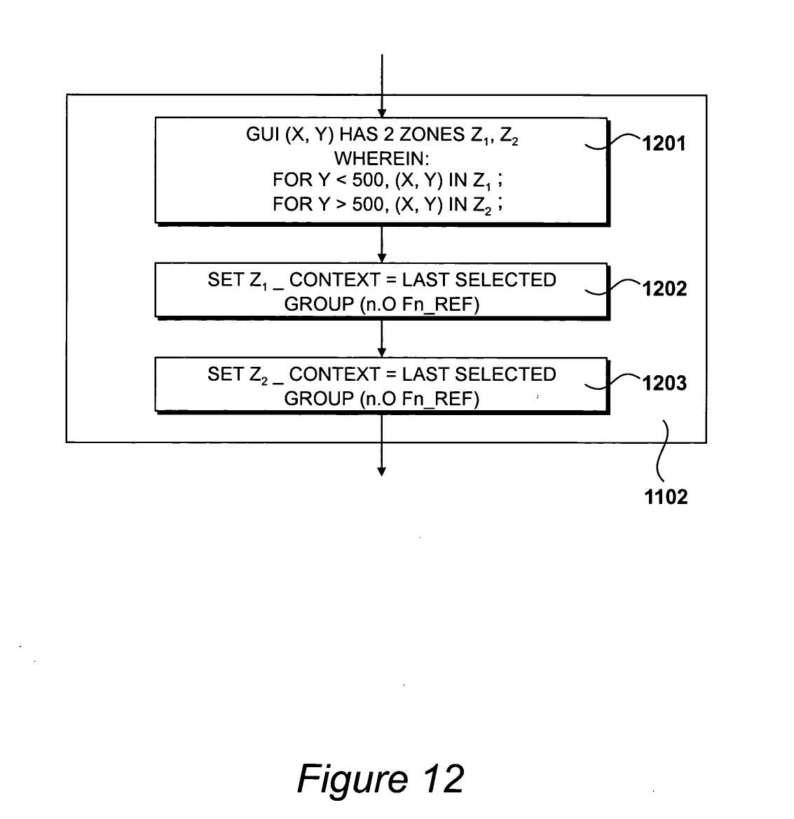

FIG. 12

The step 1102 of deriving a GUI context is further described in FIG. 12.

In the preferred embodiment of the present invention, the GUI of application 602 is configured by default with two distinct areas, expressed as two-dimensional, X, Y screen co-ordinates. Said two areas are described herein by way of example only and it will be readily understood by those skilled in the art that the present description is not limited thereto. Indeed, said two areas are described herein for the purpose of not unnecessarily obstructing the clarity of the present description, wherein said GUI may well be configured with more than two such distinct areas, for instance if said default GUI includes three or more areas respectively defined by means of their X, Y screen co-ordinates or if the multitasking environment of operating system 601 allows for application 602 to generate said second area as an overlapping window.

At step 1201, the respective X, Y screen co-ordinates conditions of the GUI of application 602 are looked up, wherein in the example, said first area Z1 of said GUI is defined as any portion of said GUI with a Y value of less than 500, i.e. in a VDU having a resolution of 2000×2000 pixels and outputting said GUI at full resolution, any portion located in the bottom quarter of said GUI. The second portion Z2 is thus defined as any portion of said GUI having X, Y screen co-ordinates with a Y value above five hundred, i.e. any portion located in the remaining, upper three quarters of said GUI.

At step 1202, application 602 assigns a context to area Z1 as the last function group 901 selected therein, for instance by means of its hierarchical reference 905 which, in the preferred embodiment of the present invention, has a “0.0” identifier 905. Similarly, at step 1203, said application 602 also assigns a context to area Z2 as said last function group 901 selected therein, for instance by means of its hierarchical reference 905 which, in the preferred embodiment of the present invention, has a “0.0” identifier 905.

In an alternative embodiment of the present invention, the reference Y value which distinguishes area Z1 from area Z2 is displayed within said GUI as a user-operable line extending from said distinguishing Y value and parallel to the horizontal X axis of the screen. Said line is user-operable in the sense that user 100 may position pointer 704 thereon and interactively edit the condition described at step 1201, for instance by means of clicking said pointer 704 over said line, then conventionally “dragging” said line along a vertical direction parallel to the vertical Y axis of the screen. In effect, in said alternative embodiment, user 100 can interactively re-size said areas Z1, Z2 in order to improve the visibility of either of said areas, to the point where said user 100 may position said line at a value of 0 or 2000, wherein either area Z1 or area Z2 is respectively displayed full-screen.

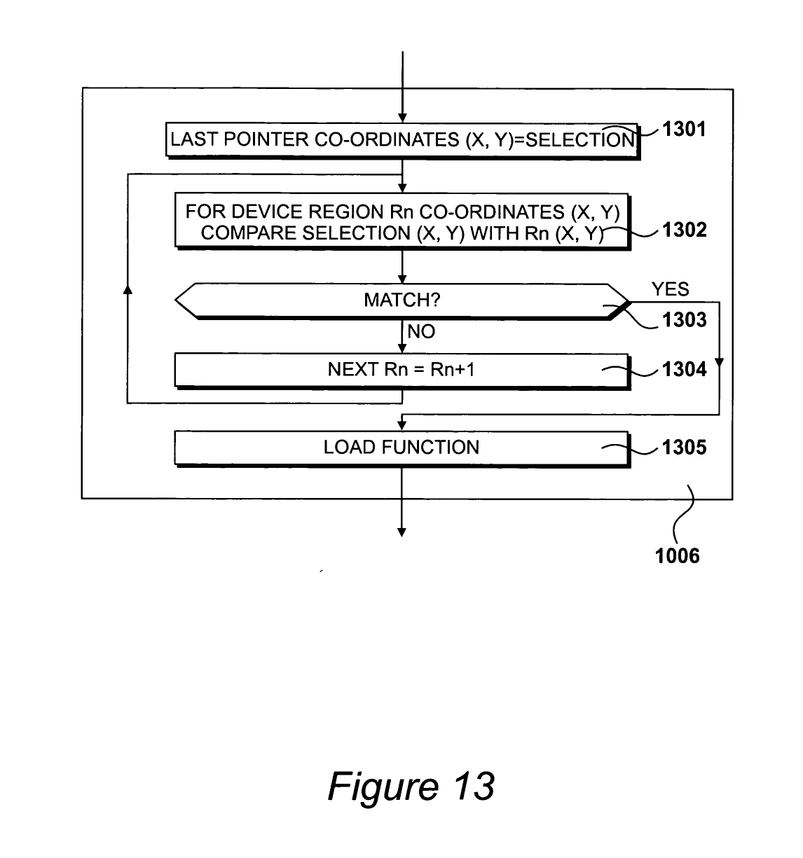

FIG. 13

The step 1008 of removing the multilateral device of the present invention upon releasing of the space bar 106 at step 1007 is further detailed in FIG. 13.

According to the present description, the pointer X, Y screen co-ordinates are processed for context data definition matching and device region generating according to step 1006 so long as said space bar 106 remains activated according to step 1005. Thus, upon interrupting the constant logical input generated from said space bar activation, the last X, Y co-ordinates of pointer 704 received before said interruption are processed as selection input data according to step 1301. At step 1302, said X, Y selection input data is compared with the respective X, Y co-ordinates of a first region Rn of the multilateral device of step 1107, whereby a question is asked at step 1303, as to whether said comparison yields a location match. That is, the X, Y selection input data is compared with the portion of the GUI assigned to a function 902 according to set step 1107.

If the question 1303 is answered negatively, the next region Rn₊₁ is selected at step 1304, whereby control is returned to step 1302 for a new comparison. A match is eventually found, whereby question 1303 is answered positively, such that the function 902 represented by said matching region is loaded at step 1305 for subsequent image processing according to further user input at step 1109.

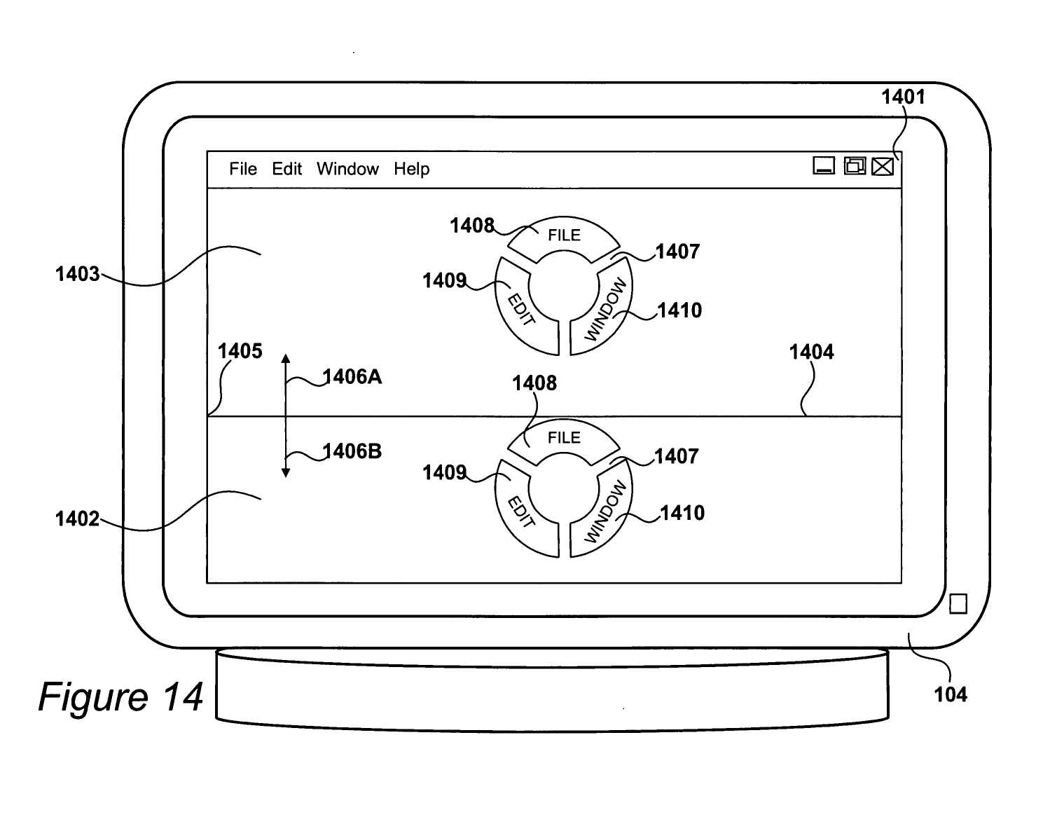

FIG. 14

The context-sensitive, multilateral device of the present invention is illustrated within the graphical user interface of an image-processing application processed by the system shown in FIGS. 1 and 2 configured according to the present invention.

VDU 104 is shown as displaying the GUI 1401 of application 602, wherein said GUI 1401 is configured with a first area Z1 1402 and a second area Z2 1403. A line 1404 of the alternative embodiment of the present invention is shown, which may be interactively repositioned by increasing its Y co-ordinate 1405 as shown at 1406A, or alternatively, decreasing said Y value 1404 as shown at 1406B.

Upon completing the starting step 503, the default context 901 respectively assigned to areas 1402, 1403 is preferably a “default” group having a “0.0” reference 905 as shown in FIG. 9 according to steps 1202, 1203 respectively. According to the present invention, user 100 preferably translates pointer 704 in either of areas 1402, 1403 and subsequently activates space bar 106 according to step 1005, whereby a context-sensitive, multilateral device 1407 is generated according to step 1006 further described in FIGS. 11 to 13. The figure shows two devices 1407 in order to illustrate both the situation in which user 100 has translated pointer 704 within area 1402 and the situation in which user 100 has translated pointers 704 in area 1403, but it will be readily apparent that said pointer 704 could not be located in both areas 1402, 1403 at once.

According to the description of the present invention, upon user 100 activating space bar 106 at step 1005, the device is divided into three regions 1408 to 1410 respectively associated with the functions 902 of the default context 901, which is common to both portions 1402, 1403 prior to selecting image data according to step 504. Thus, a first device region 1408 is associated with a “file” function, a second region 1409 is associated with an “edit” function and a third device region 1410 is associated with a “window” function 902, irrespective of the area 1402, 1403 of pointer location, because the respective contexts of said areas are the same.

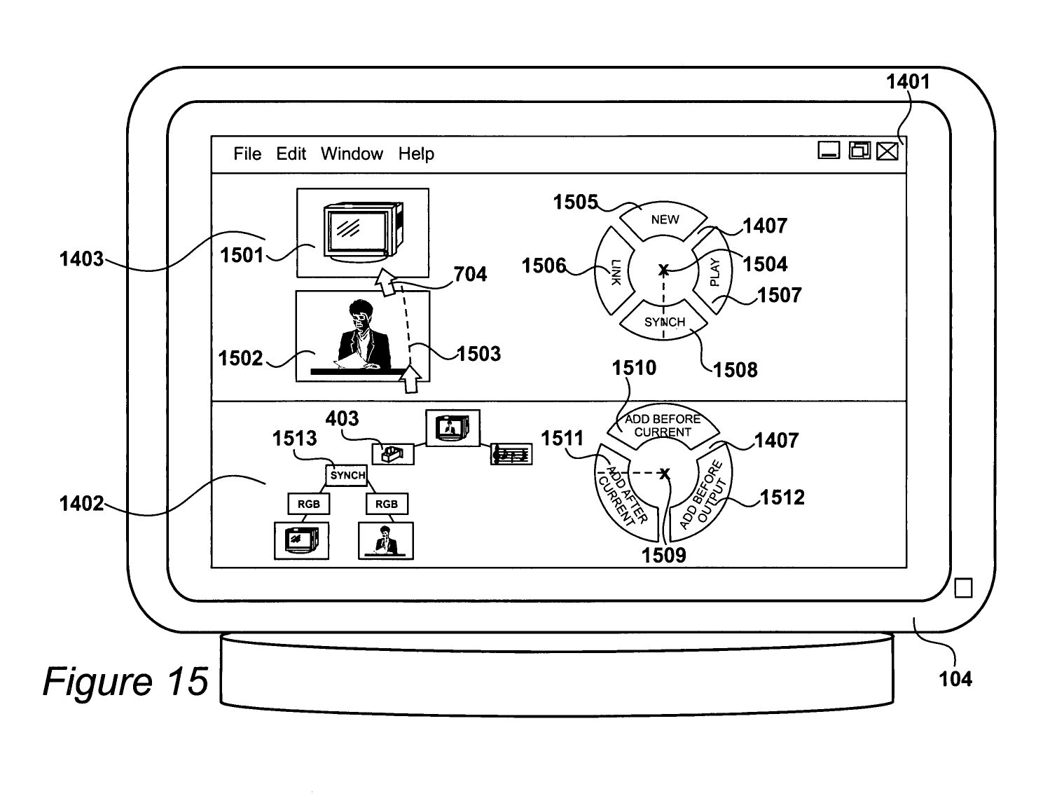

FIG. 15

The context-sensitive multilateral device 1407 is further illustrated within GUI 1401 in FIG. 15, wherein user 100 edits image data in different context.

VDU 104 again shows GUI 1401 configured with first area 1402 and second area 1403. In accordance with the description of the present invention, the situation depicted in portion 1403 has resulted from user 100 first positioning pointer 704 within said portion 1402, then activating space bar 106, then translating said pointer over “file” region 1408 and releasing said space bar 106 in order to select the “file” function, whereby upon again depressing space bar 106, a device 1407 was updated with including a plurality or regions specifically relating to said “file” function, one such region of which would for instance be an “open file” region (not shown). Upon selecting said “open file” by means of positioning pointer 704 thereon and releasing space 106, user 100 then selected image data 1501 and 1502 in order to effect the synchronisation thereof for the purpose described in FIG. 7.

In the Figure, area 1403 therefore includes image data 1501, 1502 and user 100 must now select the “synchronisation” function 902 in context 901. User 100 thus translates pointer 704 over image data 1501 according to step 1001, then selects image data 1502 according to steps 1002, 1003 and 1001 with translating said pointer 704 over a path 1503. User 100 subsequently activates space bar 106, whereby device 1407 is preferably, but not necessarily displayed with its centre 1504 having the same X, Y screen co-ordinates as the centre of said pointer 704 when said space bar is activated. In the Figure, device 1407 is shown with its centre 1504 not coinciding with pointer 704 as described above, for the purpose of not obscuring the figure unnecessarily.

User 100 thus activates spare bar 106 in order to display regions 1408, 1409 and 1410, then translates pointer 704 away from centre 1504 over to “edit” region 1409, then releases space bar 106, such that area 1403 becomes configured with an “edit” context according to step 1203. User 100 again activates space bar 106, whereby device 1407 is generated with four distinct regions 1505 to 1508 associated with the respective functions 902 of the “edit” context 901, and subsequently translates pointer 704 downward from centre 1504 over to the “synchronisation” region 1508 of updated device 1407, then releases space bar 106 according to step 1007, such that the multilateral device 1407 configured with regions 1505 to 1508 is removed from area 1403 and user 100 may now interact with said synchronisation function loaded according to step 1305 at step 1009.

It was previously described in FIG. 3 that image data such as shown at 1501, 1502 is increasingly referenced within process trees and, having regard to the hierarchical nature thereof, any effects implemented thereon necessitate a corresponding scene graph node, for instance the colour-correction node 406 required to process image frame data generated by frame node 404 prior to rendering by node 403 at step 506.

The “synchronisation” effect introduced by user 100 according to the present invention as described above therefore requires a corresponding node to be inserted at a suitable location within the scene graph of the example described in FIG. 4, such that said synchronisation effect will be performed when rendering a final output sequence of composited frames. With reference to the description of FIG. 4, it is preferable to insert a “synchronisation” processing node just before the output rendering node 403, because both the image frame sequences 1501, 1502 generated by nodes 404, 405 require respective colour correction by colour-correction nodes 406, 407, independently of one another.

According to the present invention, user 100 therefore translates pointer 704 from said location 1504 within area 1403 over to location 1509 within area 1402, the context of which is still the default context shown in FIG. 14. User 100 then interacts with device 1407 substantially as hereinbefore described in order to configure said area 1402 with a “tree” context 908 such that, upon activating space bar 106 with pointer 704 at location 1509, the multilateral device 1407 of the present invention is displayed within said area 1402 and configured with three regions 1510 to 1512 respectively associated with the function 902, 909 of said context 908, thus wherein said multilateral device 1407 is dynamically configured with a different number of regions according to the context containing pointer 704. In the example, user 100 translates said pointer 704 to the right of centre 1509 over to a “add node before output” region 1512 then releases said space bar 106, whereby a “synchronisation” processing node 1513, corresponding to the function being processed and displayed in portion 1403, is inserted in said scene graph before the output rendering node 403.

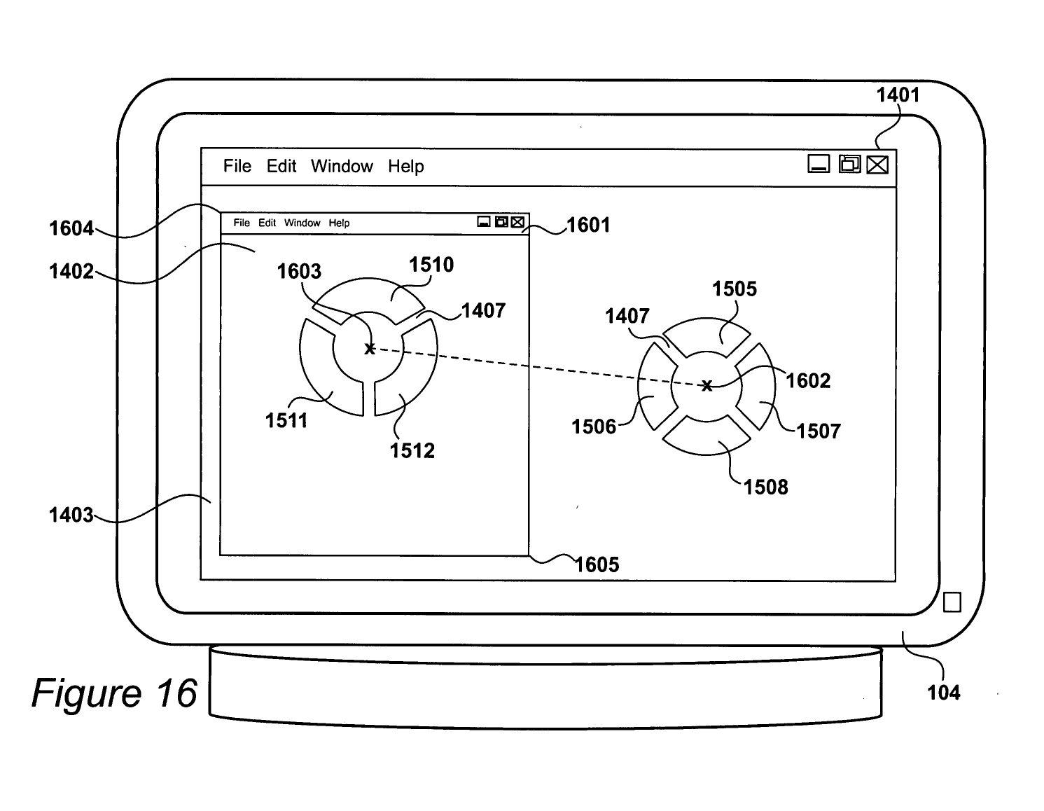

FIG. 16

An alternative embodiment of the present invention is shown is FIG. 16, wherein the GUI areas 1402, 1403 are configured as overlapping windows within a multitasking environment.

The GUI 1401 of application 602 configuring image processing system 101 according to an alternative embodiment of the present invention is shown in FIG. 16, wherein area Z1 1402 includes substantially the entire screen display area of said monitor 104. This configuration is for instance particularly useful when editing image data having a high definition, for instance movie image frames to the “2K” standard measuring two thousand pixels by two thousand (2000×2000) pixels.

In the system configured according to the alternative embodiment, the second portion 1403 is preferably generated as an overlapping window 1601 having possibly the same size as area 1402 but preferably being smaller such that the respective contents of both areas 1402, 1403 can be observed at the same time. Within multitasking environments such as generated by the windows XP operating system 601 of the preferred embodiment, said multiple, overlapping windows are well known to those skilled in the art.

With reference to the description of FIG. 15, user 100 selects and perform the “synchronisation” edit in area 1403 and, similarly, the scene graph node addition shown in area 1402 by way of pointer 704 and the context-sensitive, multilateral device 1407 of the present invention substantially as herein before described.

User 100 thus activates space bar 106 in area 1403 to display the device 1407 configured with the same four regions 1505 to 1508 necessary to select function 1508 but, upon translating said pointer 704 from a location 1602 of area 1403 to a location 1603 of area 1402 embodied as window 1601, user 100 activates said space bar 106 at location 1603, whereby said device 1407 is now configured with the same three regions 1510 to 1512.

In the alternative embodiment of the present invention, only the conditions described at step 1201 require amending, wherein the single Y reference co-ordinate 1405 is replaced by the definition of a display area 1601 expressed by means of the respective X, Y screen co-ordinates of at least two diagonally-opposed extremities 1604, 1605 thereof.

In yet another alternative embodiment of the present invention, said display area definition is dynamic, wherein said respective X, Y screen co-ordinates 1604, 1605 are edited in real time when user 100 re-sizes window 1601 according to conventional window-resizing techniques known to those skilled in the art.

1. An apparatus for processing image data in a computer system, comprising:
(a) image data;
(b) a computer system having a memory for storing the image data, a display, a user input means, and processing means, wherein the processing means is configured to:
(i) respond to a first user-generated input command to identify a context and display a plurality of context-dependent function regions at a pointer position located within said context;
(ii) process input data from input means so as to translate said pointer position to one of said function regions; and
(iii) perform a function upon said image data in response to an operator manually selecting said image data and at least one function region within the context;

2. A method of selecting a function via a graphical user interface, the method comprising:
(a) generating a first input command to identify a context and display a plurality of context-dependent function regions at a pointer position located within said context;
(b) processing input data from input means to translate said pointer position to one of said function regions.
(c) performing a function upon image data in response to an operator manually selecting:
(i) said image data; and
(ii) at least one function region within the context;

3. A computer-readable medium having computer-readable instructions executable by a computer such that, when executing said instructions, said computer will perform the steps of:
responding to a first user-generated input command so as to identify a context and display a plurality of context-dependent function regions at a pointer position located within said context;
processing input data from an input means to translate said pointer position to one of said function regions; and
performing a function upon image data in response to an operator manually selecting said image data and at least one function region within said context.
